(19) United States
(12) Patent Application Publication
(10) Pub. No.: US 2026/0012466 A1
(43) Pub. Date: Jan. 8, 2026

(54) GATED MULTI-ENCODER MACHINE LEARNING MODEL FOR DISTINGUISHING ATTACKS FROM NORMAL TRANSACTIONS

(71) Applicant: Visa International Service Association, San Francisco, CA (US)

(72) Inventors: Weijia Xu, San Francisco, CA (US); Chao Chen, San Francisco, CA (US); Pei Yang, Austin, TX (US); Zhuoyi Wang, San Francisco, CA (US); Dan Wang, Cedar Park, TX (US); Stacy Elizabeth Pelanek, San Francisco, CA (US); Younes Michael Jabbara, San Francisco, CA (US)

(73) Assignee: Visa International Service Association, San Francisco, CA (US)

(21) Appl. No.: 19/123,351

(22) PCT Filed: Jan. 19, 2024
(86) PCT No.: PCT/US2024/012198

§ 371 Date: Apr. 22, 2025

(51) Int. Cl. H04L 9/40

(52) U.S. Cl. CPC H04L 63/1416; H04L 63/1425

(57) ABSTRACT

Machine learning techniques can be applied to distinguish attacks (including enumeration attacks and account-testing attacks) from normal transaction activity. An ensemble machine learning model can include at least two generative units, one of which is trained using normal transaction data and another of which is trained using attack transaction data. Each generative unit produces a reconstructed output from a given input in a manner that reflects latent patterns in either normal or attack transactions. The reconstructed outputs and the original transaction data can be provided to as inputs to a machine learning classifier, such as a multi-label (or multi-class) classifier, that determines probability scores to different transaction types (or labels), including a first label indicating normal transactions, a second label indicating attack transactions, or a third label indicating uncertain transaction type. Based on the probability scores, the transaction can be classified as normal or attack type.

### TECHNICAL FIELD

This disclosure relates generally to detection of suspicious activity at a computer system and in particular to gated multi-encoder machine learning models for distinguishing attack transactions from normal transactions.

### BACKGROUND

Many types of internet-based activity involve accessing an account associated with a specific user (e.g., an individual). Typically, a user or client that wishes to access a service provided by a server proves their authorization by providing credentials for a valid account to the server. In the case of a login, account credentials can include a username and password. In the case of a financial transaction, account credentials can include information pertaining a financial account of the user; for instance, for a payment made via purchase card, the data may include a card number, security code (e.g., CVV), expiration date, or the like. If valid account credentials are provided to a server by a user or client that is not authorized to use those credentials, fraudulent transactions can result. Fraudulent transactions can have significant negative consequences for users and/or service providers. Accordingly, it is desirable to prevent account credentials from being obtained by unauthorized persons or entities and/or to detect when account credentials have been illicitly obtained.

In an “attack” scenario, an attacker (i.e., a person or entity seeking to perpetrate fraudulent transactions) attempts to determine valid account credentials. Examples of attacks include enumeration attacks and account-testing attacks. In an enumeration attack, the attacker may have partial account information and may attempt to guess the rest. For instance, an attacker who has a credit card account number but no other information may attempt small purchase transactions with a number of different servers, using different guesses as to the missing information. If a transaction succeeds, then the attacker can use the guessed information to make larger fraudulent purchases. In an account-testing attack, the attacker may have obtained stolen credentials and may test the credentials to see if they are valid. For instance, the attacker may attempt to make one or two small purchases to confirm that illegally-obtained purchase card information corresponds to a valid account, or the attacker may attempt to use stolen account credentials to access different servers. If successful, the attacker may feel emboldened to proceed with larger-scale fraudulent activity (e.g., making larger purchases or impersonating a user). Therefore, early detection of such attacks-ideally before the attacker succeeds in learning valid credentials-is desirable.

### SUMMARY

Existing techniques for detecting enumeration and account-testing attacks are based on rules defined from experience. In a simple example, rules can provide lists of specific accounts or servers that have been compromised. Other rules can be based on known attack patterns: for instance, repeated attempts at transactions using the same partial credential with different completions (e.g., same account number with different expiration dates or same username with different passwords), attempts at transactions with different servers using the same or similar credentials, or the like. However, rule-based approaches require enough attempted transactions that a pattern becomes apparent, and once a pattern is detected, there may be further delay before a new rule is implemented. In addition, it is relatively easy for attackers to vary the pattern of their attacks to avoid or delay detection by rules.

Certain embodiments described herein relate to systems and methods that use machine learning techniques to distinguish attacks (including enumeration attacks and account-testing attacks) from normal transaction activity. In some embodiments, a system can include an ensemble machine learning model that includes at least two generative units, one of which is trained using normal transaction data and another of which is trained using attack transaction data. Each generative unit produces a reconstructed output from a given input in a manner that reflects latent patterns in either normal or attack transactions. The reconstructed outputs and the original transaction data can be provided to as inputs to a machine learning classifier, such as a multi-label classifier (also referred to as a multi-class classifier), that determines probability scores to different transaction types (or labels). For instance, probability scores can determined for a first label indicating normal transactions, a second label indicating attack transactions, or a third label indicating uncertain transaction type. Based on the probability scores, the transaction can be classified as normal or attack type. The classification can be used to inform further processing of the transaction and/or for other purposes, examples of which are described below. In this manner, attack transactions can be identified quickly, reducing the likelihood of an attacker learning or using valid account credentials.

Some embodiments relate to a computer-implemented method that includes: obtaining transaction data for a transaction; providing the transaction data as input data to a machine learning model that has been trained to classify transactions using a set of labels, wherein the set of labels includes a first label indicating a normal transaction type, a second label indicating an attack transaction type, and a third label indicating a transaction of uncertain type, wherein the machine learning model includes: a plurality of generative units including a first generative unit associated with the normal transaction type and a second generative unit associated with the attack transaction type, wherein each of the generative units receives the input data and outputs a reconstruction of the input data, wherein the generative units operate independently of each other; a join gate that produces intermediate data by combining respective reconstruction outputs from the plurality of generative units with the input data; and a multi-label classifier unit that determines, based on the intermediate data, a probability score for each of the labels in the set of labels; and classifying the transaction as a normal transaction or an attack transaction based at least in part on the probability score for each of the labels in the set of labels.

In these and other embodiments, the method can also include: obtaining a training data set comprising transaction data for a plurality of transactions, wherein at least some of the transaction data in the training data set is initially unlabeled; and using the training data set to train the machine learning model, wherein training the machine learning model includes: directing transaction data having the first label to the first generative unit; directing transaction data having the second label to the second generative unit; and directing unlabeled transaction data and transaction data having the third label randomly to one or more of the generative units.

In these and other embodiments, all, some, or none of the transaction data in the training data set can be initially labeled.

In these and other embodiments, training of the machine learning model can include a plurality of training epochs, and at the end of each training epoch, an updated label can be assigned to the transaction data for at least one of the transactions in the training data set based on the probability scores determined by the multi-label classifier unit.

In these and other embodiments, wherein classifying the transaction can include: determining which label of the set of labels has a highest probability score; in the event that the first label has the highest probability score, classifying the transaction as a normal transaction; in the event that the second label has the highest probability score, classifying the transaction as an attack transaction; and in the event that the third label has the highest probability score: determining which label of the set of labels has a second-highest probability score; in the event that the first label has the second-highest probability score, classifying the transaction as a normal transaction; and in the event that the second label has the second-highest probability score, classifying the transaction as an attack transaction.

In these and other embodiments, the method can further include assigning an uncertainty score to the classification of the transaction as a normal transaction or an attack transaction based on the probability score for the third label.

In these and other embodiments, the transaction data can be received while a transaction is in progress, and the method can further include: determining whether to allow or reject the transaction based at least in part on whether the transaction is classified as a normal transaction or an attack transaction.

Some embodiments relate to a computer system that can include: a communication interface to communicate with one or more server systems; a memory to store transaction data for a plurality of previous transactions including a plurality of normal transactions and a plurality of attack transactions; and a processor coupled to the memory and configured to implement a machine learning model that includes: a plurality of generative units including a first generative unit associated with a normal transaction type and a second generative unit associated with an attack transaction type, wherein each of the generative units receives input data representing a transaction and outputs a reconstruction of the input data, wherein the generative units operate independently of each other; a join gate that produces intermediate data by combining respective outputs from the plurality of generative units with the input data; and a multi-label classifier unit that determines, based on the intermediate data, a probability score for each label in a set of labels, wherein the set of labels includes a first label indicating the normal transaction type, a second label indicating the attack transaction type, and a third label indicating a transaction of uncertain type, wherein the processor is further configured to: train the machine learning model using the stored transaction data; receive, via the communication interface, new transaction data from one of the one or more server systems; use the trained machine learning model to determine, for the new transaction data, a probability score for each of the labels in the set of labels; and classifying the transaction as a normal transaction or an attack transaction based at least in part on the probability score for each of the labels in the set of labels.

In these and other embodiments, at least one of the generative units can include a variational autoencoder.

In these and other embodiments, the multi-label classifier unit can include a feed-forward neural network having one or more layers.

In these and other embodiments, the transaction data for each transaction can include an account credential provided by a client system to the server system, wherein the normal transaction type corresponds to an authorized use of the account credential and wherein the attack transaction type corresponds to an attempted or successful unauthorized use of the account credential.

In these and other embodiments, the processor can be further configured such that training the machine learning model includes: defining a training data set using at least a portion of the stored transaction data, wherein the training data set initially includes at least some transactions having the first label, at least some transactions having the second label, at least some transactions having the third label and at least some unlabeled transactions; directing transaction data for transactions having the first label to the first generative unit; and directing transaction data having the second label to the second generative unit.

In these and other embodiments, the processor can be further configured such that training the machine learning model includes: randomly directing each of the transactions having the third label to one or the other of the first generative unit or the second generative unit; and randomly directing each of the unlabeled transactions to one or the other of the first generative unit or the second generative unit.

In these and other embodiments, the processor can be further configured such that training the machine learning model includes: directing a randomly selected subset of the transactions having the third label to both of the first generative unit and the second generative unit; and directing a randomly selected subset of the unlabeled transactions to both of the first generative unit and the second generative unit.

In these and other embodiments, training of the machine learning model can include a plurality of training epochs, and the processor can be further configured such that, at the end of each training epoch, updated labels are determined for transactions in the training data set that have the third label and for unlabeled transactions, wherein the updated label for a transaction is determined based on the probability scores determined by the multi-label classifier unit.

Some embodiments relate to a computer-readable storage medium having stored therein program code instructions that, when executed by a processor in a computer system, cause the processor to perform a method comprising: obtaining transaction data for a transaction; providing the transaction data as input data to a machine learning model that has been trained to classify transactions using a set of labels, wherein the set of labels includes a first label indicating a normal transaction type, a second label indicating an attack transaction type, and a third label indicating a transaction of uncertain type, wherein the machine learning model includes: a plurality of generative units including a first generative unit associated with the normal transaction type and a second generative unit associated with the attack transaction type, wherein each of the generative units receives the input data and outputs a reconstruction of the input data, wherein the generative units operate independently of each other; a join gate that produces intermediate data by combining respective outputs from the plurality of generative units with the input data; and a multi-label classifier unit that determines, based on the intermediate data, a probability score for each of the labels in the set of labels; and classifying, based at least in part on the probability score for each of the labels in the set of labels, the transaction as a normal transaction or an attack transaction.

In these and other embodiments, the method can further include: obtaining a training data set comprising transaction data for a plurality of transactions, wherein at least some of the transaction data in the training data set is initially unlabeled; and using the training data set to train the machine learning model, wherein training the machine learning model includes a plurality of training epochs and wherein, during each epoch: transaction data having the first label is directed to the first generative unit; transaction data having the second label is directed to the second generative unit; and unlabeled transaction data and transaction data having the third label is directed randomly to zero or more of the generative units.

In these and other embodiments, the method can further include, after each training epoch: applying the machine learning model to unlabeled transaction data and transaction data having the third label to determine probability scores for each of the labels in the set of labels; and determining updated labels for the unlabeled transaction data and transaction data having the third label based on the probability scores for each of the labels in the set of labels.

In these and other embodiments, the transaction data can be received from a server computer and the method can further include: transmitting a report to the server computer, the report indicating whether the transaction was classified as a normal transaction or an attack transaction. In these and other embodiments, the report can further includes an uncertainty score based on the probability score for the third label.

The following detailed description, together with the accompanying drawings, will provide a better understanding of the nature and advantages of the claimed invention.

### BRIEF DESCRIPTION OF THE DRAWINGS

FIG. 1 shows a simplified block diagram of a system in which some embodiments can operate.

FIG. 2 shows a simplified block diagram of a machine learning model according to some embodiments.

FIG. 3 shows a flow diagram of a process for training a machine learning model according to some embodiments.

FIG. 4 shows a simplified block diagram of a machine learning model in inference mode according to some embodiments.

FIG. 5 shows a flow diagram of a process for operating a machine learning model in inference mode according to some embodiments.

FIG. 6 shows a flow diagram of a process for determining classification of a transaction according to some embodiments.

FIG. 7 shows a simplified block diagram of a machine learning model according to some embodiments.

### TERMS

The following terms may be used herein.

A “computer system” refers generally to a device or apparatus that is capable of executing program code (also referred to as “instructions”). A computer system can include a processor and a memory, as well as other components such as user interfaces that enable human interaction with the computer system and/or communication interfaces that enable computer systems to exchange information-bearing signals with other computer systems.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s). A processor can also include one or more co-processors that operate under control of a CPU to perform specific tasks; examples include graphics processors, neural processors, and the like.

A “server computer,” “server system,” or “server,” may refer to a computer or cluster of computers. A server computer may be a powerful computing system, such as a large mainframe. Server computers can also include minicomputer clusters or a group of servers functioning as a unit. In one example, a server computer can include a database server coupled to a web server. In another example, a server computer can include a collection of processors, a communication interface that receives requests to execute jobs using the processors, and a control system that assigns jobs to specific processors. A server computer may comprise one or more computational apparatuses and may use any of a variety of computing structures, arrangements, and compilations for servicing requests from one or more client computers.

A “client computer,” “client system,” or “client,” may refer to a computer or cluster of computers that receives some service from a server computer (or another computing system). The client computer may access this service via a communication network such as the internet or any other appropriate communication network. A client computer may make requests to server computers, including requests to retrieve or update data or requests to purchase goods or services. As some examples, a client computer can send a request to a server computer to access a user account to retrieve and/or update data in a database maintained by the server computer, or a client computer can send a request to a server computer to charge a purchase of goods or services to a purchase card or other financial account. A client computer may comprise one or more computational apparatuses and may use a variety of computing structures, arrangements, and compilations for performing its functions, including requesting and receiving data or services from server computers.

A “transaction” may refer generally to an interaction in which a client computer or client system seeks to obtain something (e.g., data, goods, services) from or via a server computer or server system. A transaction may require the client (or a user of the client computer) to provide account credentials as evidence that the user is authorized to obtain what is sought and/or to facilitate completion of the transaction. As some examples, a username and password may be required to authorize access to data; or a card number, expiration data, and other information may be required to authorize a purchase of goods or services.

“Account credentials,” or “credentials,” can include any combination of information items that can be used by a server system to determine whether a client system or a particular user of a client system is authorized to perform a transaction with the server system. Examples of account credentials include username, password, email address, account number, additional account information (such as an expiration date of a purchase card, card verification value (CVV)), etc. Account credentials may be subject to verification by the server prior to authorizing a transaction. Depending on implementation, the server may perform its own verification and/or communicate with one or more other servers to verify the credentials.

A “machine learning model” may refer to a file, program, software executable, instruction set, etc., that has been “trained” to recognize patterns or make predictions. For example, a classifier is a type of machine learning model that can receive input data and determine a probability that the input data belongs to each of a plurality of categories, where each category is identified by a label. As another example, a generative model can take input data (represented as a sequence or feature vector) and generate an output that is a variation or extension of the input, based on patterns learned during training. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

### DETAILED DESCRIPTION

The following description of exemplary embodiments is presented for the purpose of illustration and description. It is not intended to be exhaustive or to limit the claimed embodiments to the precise form described, and persons skilled in the art will appreciate that many modifications and variations are possible. The embodiments have been chosen and described in order to best explain their principles and practical applications to thereby enable others skilled in the art to best make and use various embodiments and with various modifications as are suited to the particular use contemplated.

### System Overview

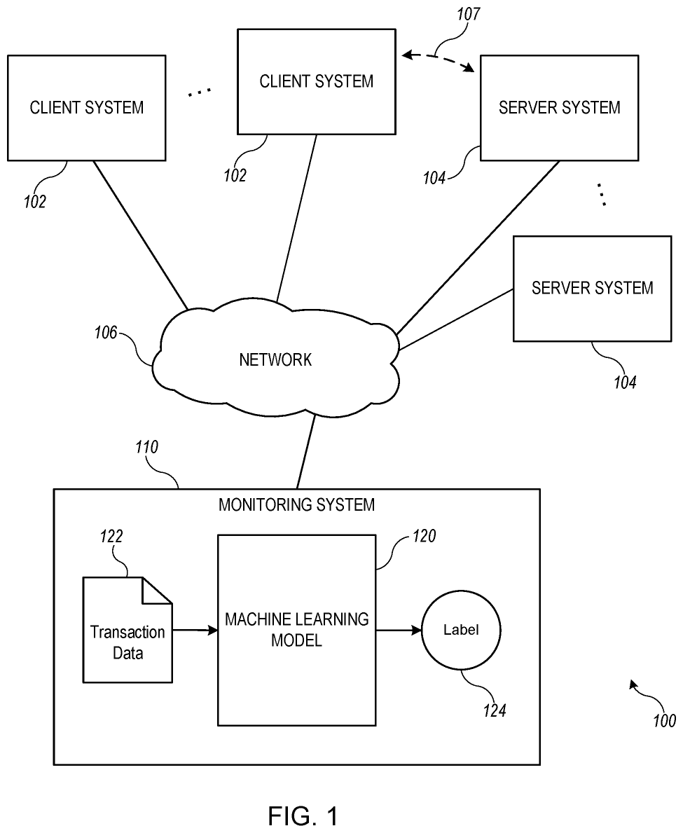

FIG. 1 shows a simplified block diagram of a system 100 in which some embodiments can operate. System 100 includes a number of client systems 102 communicating with various server systems 104 via a network 106, which can be, e.g., the internet, a local area network, a private network or any other network. In some instances, a particular client system 102 can interact with one of server systems 104 to perform a transaction, as suggested by dashed arrow 107. The transaction can be of a type that involves verification that a user of client system 102 should be permitted to perform the transaction. For example, server system 104 may request account credentials from client system 102. In response, client system 102 may prompt the user to enter the appropriate account credentials (or client system 102 may retrieve locally-stored account credentials for the user). Client system 102 can transmit the account credentials (preferably in a secure manner) to server system 104, and server system 104 can determine whether the account credentials are valid or not. If the credentials are valid, the transaction can be allowed; if not, the transaction can be rejected (or blocked).

Various server systems 104 can support many different types of transactions, and the account credentials can depend on the particular transaction. For instance, in a transaction where a user retrieves data from server system 104 or adds data to server system 104, the user (via client system 102) may be required to provide a username and password and possibly other information as well (e.g., a one-time code or answer to a security question). In a purchase transaction, the user may be required to provide an account number (e.g., a credit card primary account number), security code (e.g., card verification value, or CVV), expiration date, partial or complete billing address (e.g., zip code), and/or other information. In some instances, multiple server systems 104 may be involved in a transaction. For example, a client system 102 can be used to order goods or services via a first server 104. In connection with the transaction, the user may supply account credentials for a financial account, and first server 104 may communicate with a second server system 104 to verify the account credentials and apply a charge to the financial account. More generally, one server system 104 may communicate with another server system 104 to validate account credentials received from a client. The particular implementation of transactions, including verification of account credentials, can be modified as desired without departing from the scope of the present disclosure.

Users can use client systems 102 to conduct transactions with server systems 104. As used herein, a “normal” transaction refers to a transaction in which the user is in fact authorized to use the account credentials presented in connection with that transaction, including transactions where the user initially makes an error in entering an account credential and corrects the error when prompted to re-enter the credential. It is expected that most transactions will be of the normal type. A “fraudulent” transaction refers to a transaction in which the user gains authorization via account credentials that the user knows they are not authorized to use, as is the case where the user has stolen or guessed the credentials. An “attack” transaction refers to an attempt at a fraudulent transaction. For instance, an attacker may attempt to guess valid credentials (an “enumeration attack”), an attacker may to test the validity of illicitly-obtained credentials (an “account-testing attack”) by performing a transaction with an unsuspecting server system 104.

To avoid detection, attackers may attempt to keep a low profile. For instance, attackers may attempt small purchases or make innocuous-seeming data requests in order to determine whether known or guessed credentials are valid. In addition, the attacker may attempt such transactions with different server systems 104 (e.g., using different guesses at the credentials) to make attacks more difficult to detect. If the attacker learns valid credentials, the attacker may escalate, e.g., to larger fraudulent purchases, compromise or destruction of data, or other harmful activities.

According to some embodiments, attack transactions can be detected using a monitoring system 110 that is connected to network 106. Monitoring system 110 can communicate with any or all of server systems 104 to determine whether an attempted or completed transaction is normal or a likely attack. For example, monitoring system 110 can maintain a machine learning model 120, implementations of which are described below. Machine learning model 120 can be trained to receive transaction data 122 for a transaction and assign a label 124 to the transaction data 122. Label 124 can indicate, for example, whether the transaction is probably normal or probably an attack. In some embodiments, a confidence score, such as probability score or uncertainty score, can be associated with label 124.

Monitoring system 110 can be used for various purposes. In some embodiments, one or more server systems 104 can send transaction data 122 for a transaction to monitoring system 110 in real time (while a transaction is in progress). Monitoring system 110 can return a report, which can include label 124 and a confidence score, to server system 104. Server system 104 can use the report to determine whether to approve or reject the transaction. As another example, in some embodiments monitoring system 110 can use label 124 to determine whether to approve or reject the transaction and can send an approval or rejection to server system 104. In addition to or instead of real-time monitoring, monitoring system 110 can also periodically receive batches of transaction data from one or more server systems 104 and analyze the transaction data using machine learning model 120 to identify likely attacks, to assess current levels of attack activity, and/or to detect emerging attack patterns. Regardless of whether monitoring system 110 is used in real-time or in batch mode, monitoring system 110 can notify server systems 104 of attacks, and server systems 104 can take appropriate remedial action, such as rejecting transactions, invalidating account credentials used in an attack, contacting users whose credentials may have been compromised, reporting the attack to law enforcement, or the like.

It will be appreciated that system 100 is illustrative of one context in which detecting attack transactions can be useful. Techniques used herein can be applied in any context where a server system receives and processes transaction requests from client systems. A monitoring system 110 can interact with any number (one or more) of server systems 104. In various embodiments, monitoring system 110 and the server system(s) 104 with which monitoring system 110 interacts can be operated by the same entity or by different entities.

### Machine Learning Model for Attack Detection

To date, use of machine learning to detect attack transactions has been limited, in part because conventional machine learning classifiers perform optimally when training data is balanced among the classifications (or labels) being learned. In the case of transactions between clients and servers, attacks generally constitute only a small fraction of all transactions, and the imbalance between attack transactions and normal transactions in the training data can confound the machine learning process. Certain embodiments described herein provide machine learning models that can perform effectively with imbalanced training data and/or unlabeled training data.

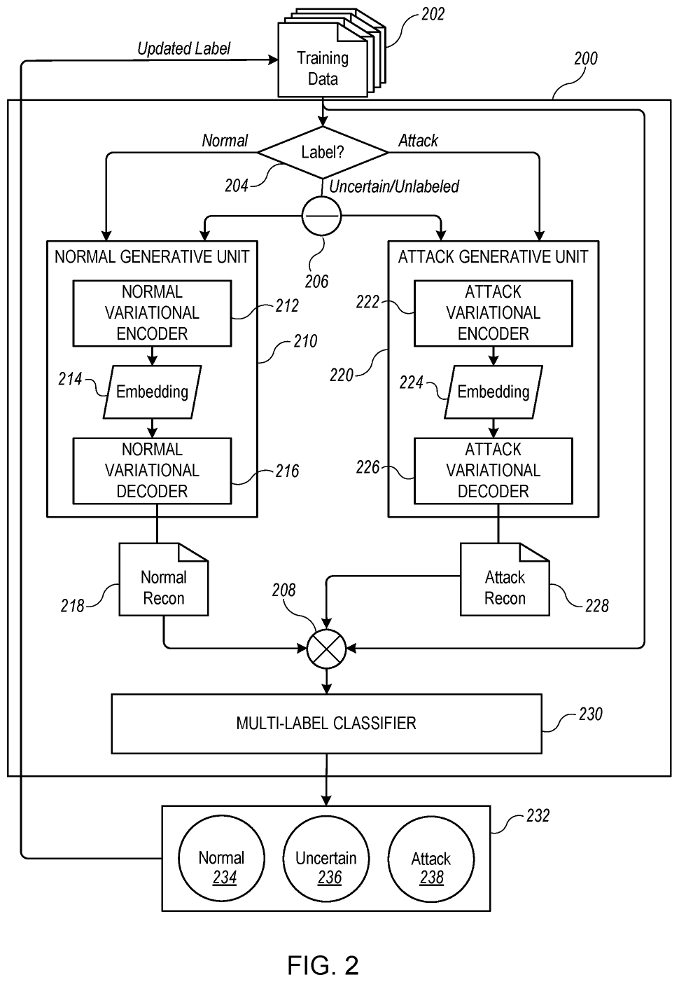

FIG. 2 shows a simplified block diagram of a machine learning model 200 according to some embodiments. Machine learning model 200 can be used, e.g., to implement machine learning model 120 of FIG. 1. Machine learning model 200 can be an ensemble model that includes a “normal” generative unit 210, an “attack” generative unit 220, and a multi-label classifier unit 230. In FIG. 2, machine learning model 200 is shown in a training mode.

In training mode, machine learning model 200 can receive training data 202. Training data 202 can include transaction data from previous transactions, including any combination of accepted and rejected transactions at any number of server systems 104. The transaction data for a given transaction can include any information about the transaction, including any or all of the following: credentials used; whether credentials were determined to be valid; information about the client system (e.g., IP address; identifier of an internet service provider (ISP) used by the client system; and/or client platform information including hardware type, operating system, particular application program used to access the server, hardware or software version information,); information about the server system (e.g., IP address, owner/operator of the server, server platform information); date and time; whether the transaction was allowed or rejected; and/or other information (e.g., number of errors in entering credentials during the transactions; specific items downloaded, uploaded, or ordered; monetary value of a purchase; user address information; recent transactions prior to the current transaction). While machine learning model 200 can be applied in a variety of contexts, it is preferable to select training data pertaining to a single category of account credentials. For instance, attacks aimed at guessing or testing login credentials may have different characteristics from attacks aimed at guessing or testing account credentials for a purchase card. Accordingly, a particular implementation of machine learning model 200 can be trained to analyze transactions involving a specific category of account credentials (e.g., either login credentials or purchase-card credentials but not both in the same implementation) If desired, multiple implementations of machine learning model 200 can be provided to support detection of attacks targeting different categories of account credentials.

For each transaction in the training data set, input data (e.g., an input feature vector representing some or all of the transaction data) can be defined. The input feature vector can be input to one or both of normal generative unit 210 and/or attack generative unit 220. For example, normal generative unit 210 can be a variational autoencoder (VAE) unit with a variational encoder 212 that produces a latent space embedding 214 and a variational decoder 216 that produces a “normal” reconstruction 218 (e.g., as a feature vector having the same dimensionality as the input feature vector). Similarly, attack generative unit 220 can also be a VAE unit with a variational encoder 222 that produces a latent space embedding 224 and a variational decoder 226 that produces an “attack” reconstruction 228 (e.g., as another feature vector having the same dimensionality as the input feature vector). Generative units 210, 220 can be implemented using conventional or other techniques, and different generative units can have identical, similar, or different structures (e.g., number of encoding and/or decoding layers, dimensionality of the latent space). Even where normal generative unit 210 and attack generative unit 220 have identical structures, normal generative unit 210 and attack generative unit 220 can be trained on systematically different data (as described below); consequently, a normal reconstruction 218 and an attack reconstruction 228 generated from the same input transaction are expected to exhibit systematic differences.

A join gate 208 can receive normal reconstruction 218, attack reconstruction 228, and the input feature vector for the transaction and can produce, as intermediate data, a concatenated or combined representation of normal reconstruction 218, attack reconstruction 228, and the input feature vector. For instance, join gate 208 can concatenate feature vectors for the input data, normal reconstruction 218, and attack reconstruction 228. In this case, if the input feature vector has n dimensions (or components), join gate 208 produces intermediate data in the form of a feature vector having dimension 3n. As another example, join gate 208 can compute a first difference vector representing the difference between the input feature vector and the normal reconstruction vector and a second difference vector representing the difference between the input feature vector and the attack reconstruction vector, then concatenate the first and second difference vectors. In this case, if the input feature vector has n dimensions (or components), join gate 208 produces intermediate data in the form of a feature vector having dimension 2n. The reduction in dimension may reduce computational burden with negligible information loss.

Multi-label classifier unit 230 can be implemented, e.g., using a feed-forward neural network having any number of fully connected layers. Suitable classifiers can be implemented using conventional or other techniques. Multi-label classifier unit 230 can map the output feature vector from join gate 208 onto a probability score for each label in a defined set of labels 232. In this example, the set of labels 232 includes a “Normal” label having a normal probability score 234, an “Attack” label having an attack probability score 236 and an “Uncertain” label having an uncertain probability score 238. The “Uncertain” label can be used to identify feature vectors that are intermediate between the normal and attack types. In some embodiments, probability scores for the labels can be normalized such that their sum is 1. The labels can correspond to different classes, and the terms “multi-label classifier” and “multi-class classifier” are used interchangeably herein.

Training of a machine learning model involves automated processes to determine, or “learn,” optimal values for internal parameters of the model, such as the weights for each node or coefficients of a parametric function such as a curve-fitting function or a transform function. A standard approach to training involves iteratively processing data samples through the model and adjusting the parameters of the model, with the goal of minimizing a loss function that characterizes a difference between the output of the model for a given input and an expected result determined from a source other than the model. Loss functions can be selected based in part on the particular model, and optimization of loss functions can proceed using various techniques. Examples of loss functions for machine learning model 200 are described below. Training typically occurs across multiple “epochs,” where each epoch corresponds to a pass through the training sample set. Adjustment to parameters of the model (e.g., weights or coefficients) can occur multiple times during an epoch; for instance, the training data can be divided into “batches” or “mini-batches” and weight adjustment can occur after each batch or mini-batch. Aspects of machine learning models and training that are relevant to understanding the present disclosure are described herein; any other aspects can be modified as desired.

For training of machine learning model 200, training data 202 can initially include any combination of labeled and unlabeled transaction data. For instance, during preparation of training data 202, human reviewers or rule-based analysis can be used to label some (or all) transactions as Normal, Attack, or Uncertain. As described below, pre-labeling of training data 202 is not required, and machine learning model 200 can learn from initially unlabeled training data.

Label gate 204 and selection gate 206 can be used to direct transaction data for a given transaction to one or the other (or both) of normal generative unit 210 or attack generative unit 220. In some embodiments, when transaction data is sent to only one of normal generative unit 210 or attack generative unit 220, an empty (or null) vector is sent to the other of normal generative unit 210 or attack generative unit 220. More specifically, label gate 204 can read any label that has ben applied to the transaction data. If the Normal label has been applied, label gate 204 can direct the transaction data to normal generative unit 210 (and an empty vector to attack generative unit 220). If the Attack label has been applied, label gate 204 can direct the transaction data to attack generative unit 220 (and an empty vector to normal generative unit 210). If the Uncertain label has been applied, or if the transaction data is unlabeled, label gate 204 can direct the transaction data to selection gate 206.

Selection gate 206 can be implemented to randomly (or quasi-randomly) assign transactions to one, both, or neither of normal generative unit 210 and attack generative unit 220. As one example, selection gate 206 can implement a random drop-out gate that directs a predefined fraction (or subset) of transactions received at selection gate 206 (which would be only the transactions having no label or the Uncertain label) to both of normal generative unit 210 and attack generative unit 220; other transactions received at selection gate 206 are not directed to either generative unit (these transactions drop out for the current training epoch). As another example, selection gate 206 can implement a random split gate that, for each transaction received at selection gate 206 (which would be only the transactions having no label or the Uncertain label), randomly directs the transaction data to one or the other of normal generative unit 210 or attack generative unit 220 and directs an empty vector to the non-selected one of normal generative unit 210 or attack generative unit 220. Examples of operation of selection gate 206 are described below.

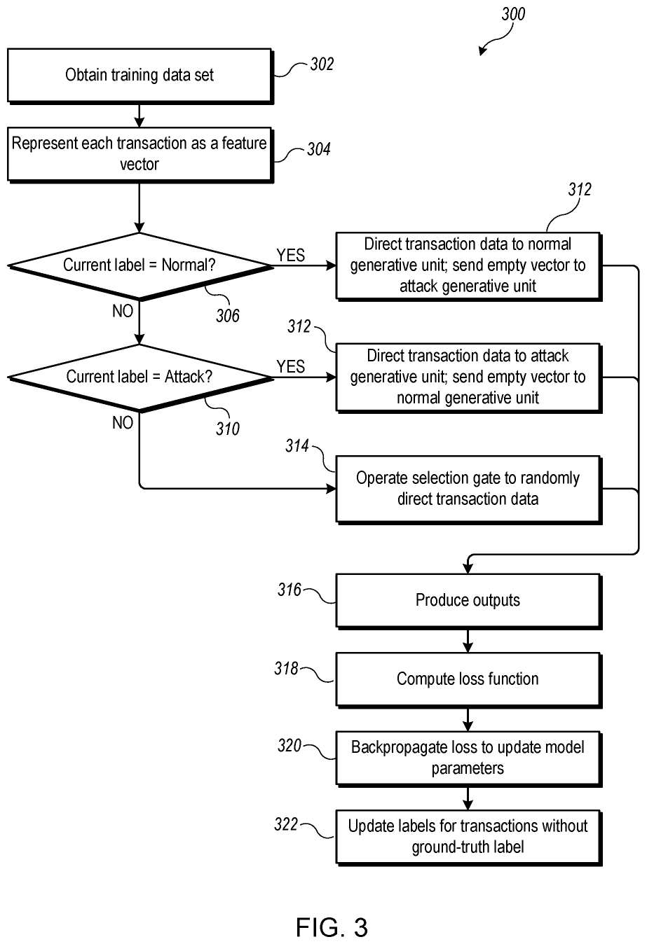

FIG. 3 shows a flow diagram of a process 300 for training machine learning model 200 according to some embodiments. At block 302, a training data set is obtained. The training data set can include transaction data from a large number of transactions. None, some, or all of the transactions can be labeled with a ground truth label that identifies the transaction as Normal or Attack. At block 304, each transaction in the training data set can be represented as a feature vector, which can include representations of all of the available information about the transaction or a subset of the available information. If desired, the training data set can be divided into multiple batches.

Per-transaction logic is applied to route the transaction data into the generative units based at least in part on the ground truth labels assigned to transactions. If, at block 306, a particular transaction has been labeled as a Normal transaction, then at block 308, the transaction data (feature vector) for that transaction is directed (e.g., by label gate 204) to normal generative unit 210 and an empty vector is directed to attack generative unit 220. Conversely, at block 310, if a particular transaction has been labeled as an Attack transaction, then at block 312, the transaction data (feature vector) for that transaction is directed (e.g., by label gate 204) to attack generative unit 220 and an empty vector is directed to normal generative unit 210. At block 314, if a particular transaction is unlabeled or has the Uncertain label, then selection gate 206 can be operated to direct the transaction data (feature vector) randomly to zero or more of the generative units. For example, selection gate 206 can implement a random drop-out gate that directs a predefined fraction x of transactions received at selection gate 206 to both of normal generative unit 210 and attack generative unit 220. The predefined fraction x can be defined to reflect a level of general uncertainty, such as the expected fraction of borderline cases, which can be determined from experience. In this context, “borderline cases” can include cases involving incorrect credentials, which often are not due to attempted fraud, such as cases where the user initially makes an error in entering an account credential and corrects the error when prompted to re-enter the credential. (As a specific example, in an embodiment where 20% of transactions are expected to be borderline cases, x can be 0.20.) In this example, when selection gate 206 receives a transaction, selection gate 206 can generate a random number (uniformly distributed between 0 and 1) and compare the random number to the predefined fraction x. If the random number is above the predefined fraction x, then selection gate 206 can direct the transaction data (feature vector) to both of normal generative unit 210 and attack generative unit 220; otherwise, the transaction is not used (dropped out) in the current training epoch. In this manner, the transaction data for a randomly selected subset of unlabeled transactions and transactions having the Uncertain label can be directed to both of normal generative unit 210 and attack generative unit 220.

As another example, in some embodiments selection gate 206 can implement a random split gate that randomly directs transactions to one or the other of normal generative unit 210 or attack generative unit 220. Similarly to the random drop-out example, a predefined fraction x can be defined to reflect the expected ratio of attack transactions to normal transactions, which can be determined from experience. (As a specific example, in an embodiment where 99% of transactions are expected to be normal, x can be 0.01.) When selection gate 206 receives a transaction, selection gate 206 can generate a random number (uniformly distributed between 0 and 1) and compare the random number to the predefined fraction x. In this case, however, if the random number is lower than the predefined fraction x, then selection gate 206 can direct the transaction data (feature vector) to attack generative unit 220 (and an empty vector to normal generative unit 210), and if the random number is higher than the predefined fraction x, then selection gate 206 can direct the transaction data (feature vector) to normal generative unit 210 (and an empty vector to attack generative unit 220).

At block 316, normal generative unit 210, attack generative unit 220, join gate 208, and multi-label classifier unit 230 operate on the received transaction data (feature vectors) as described above to produce outputs. For each transaction, the outputs can include a normal reconstruction 218, an attack reconstruction 228, and probability scores 234, 236, 238 for the labels in label set 232.

At block 318, a loss function can be computed for each batch. For instance, where normal generative unit 210 and attack generative unit 220 are implemented as variational autoencoders, a feature vector vᵢ input into either unit produces a reconstructed output

$${v}_{i}^{j} ,$$

where subscript index i identifies the data sample and superscript index j identifies the particular generative unit (e.g., j=1 for normal generative unit 210, j=2 for attack generative unit 220). The loss function for a given generative unit and feature vector can be defined as a distance between the input feature vector the reconstructed output, that is:

$${ℒ}_{i}^{j} = 𝒟 ( {v}_{i} , {v}_{i}^{j} ) . \qquad ( 1 )$$

Distance metric [symbol] (·) can be, e.g., a Euclidean distance or other distance metric.

For multi-label classifier unit 230, the loss function for the label mapping can be defined as:

$${ℒ}_{i}^{′} = {\sum }_{l = 1}^{2} \vert {p}_{i}^{l} - {t}_{i}^{l} \vert , \qquad ( 2 )$$

where index l identifies a label, [symbol] is the probability score output for label l by multi-label classifier unit 230, and [symbol] is equal to 1 if label l is the ground-truth label and equal to 0 otherwise. In this example, loss is computed only for input data with Normal or Attack labels; for input feature vectors that are unlabeled or labeled as Uncertain, the loss for multi-label classifier unit 230 is set to 0.

The total loss function for each batch (computed at block 316) can be defined as:

$${ℒ}_{total} = {\sum }_{i} ( w * {ℒ}_{i}^{′} + {\sum }_{j = 1}^{2} {ℒ}_{i}^{j} ) , \qquad ( 3 )$$

where w is a weight factor (a hyperparameter of the model) and the sum is taken over all training samples i in the batch.

At block 318, after processing a batch, the loss can be backpropagated through the model to adjust the weights in each layer of variational encoders 212, 222, variational decoders 216, 226, and multi-label classifier unit 230. Conventional or other backpropagation techniques can be used.

At block 320, after each training epoch, any transactions that do not have a ground truth label or for which the ground truth label is Uncertain can be updated using predictions from machine learning model 200 (operating in inference mode, as described below). For instance, if the probability score for either the Normal label (probability score 234) or the Attack label (probability score 238) exceeds a threshold (e.g., 50% or 60% probability), the transaction can be assigned the corresponding label. If neither probability score exceeds the threshold, the transaction can be labeled as Uncertain. In some embodiments, once a transaction has been assigned either the Normal label or the Attack label, the label for that transaction remains fixed for the duration of training. Thus, as training progresses, more of the training data can acquire Normal or Attack labels.

While FIG. 3 shows only one training epoch, it should be understood that additional training epochs can be performed as desired. In some embodiments, training can continue until a stopping criterion is met. Suitable techniques for defining stopping criteria are known in the art. Using process 300, machine learning model 200 can learn patterns of attacks, including attacks that may not have happened yet.

Process 300 can support supervised, semi-supervised, or unsupervised training. Thus, the training data set can initially include any combination of labeled and unlabeled transaction data. Labels can be assigned to initially unlabeled transactions as training progresses, as described above. In some embodiments, training can be repeated as additional training data becomes available (continuously or on a regular basis, such as daily, weekly, or monthly), thereby allowing machine learning model 200 to learn newly emerging attack patterns.

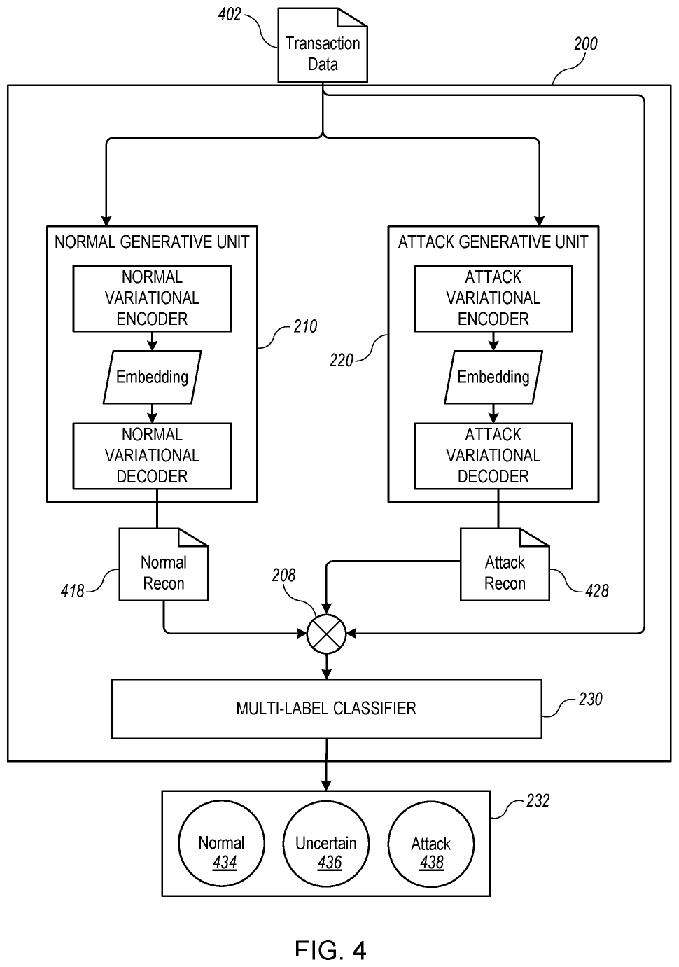

After initial training, machine learning model 200 can be used in an “inference” mode to apply labels to new (or previously unseen) transactions. FIG. 4 shows a simplified block diagram of machine learning model 200 in inference mode according to some embodiments. In inference mode, transaction data 402 for a transaction that is to be labeled can be represented as a feature vector and input to both normal generative unit 210 and attack generative unit 220. (Label gate 204 and selection gate 206 are not used in inference mode.) Normal generative unit 210 can produce a normal reconstruction 418 from transaction data 402, while attack generative unit 220 can produce an attack reconstruction 428. It should be understood that because normal generative unit 210 and attack generative unit 220 were trained using different types of transactions, normal reconstruction 418 and attack reconstruction 428 for the same input transaction data 402 will generally be different. Join gate 208 can combine or concatenate the input transaction data 402 with normal reconstruction 418 and attack reconstruction 428 (in the same manner as in training mode), and multi-label classifier unit 230 can use the output of join gate 208 as input to be mapped to probability scores for each of the labels in label set 232. Thus, in inference mode, machine learning model 200 can produce a Normal probability score 434, an Attack probability score 438, and an Uncertain probability sore 436 for the transaction. In some embodiments, probability scores 434, 436, 438 can be used to classify the transaction as either a normal transaction or an attack transaction.

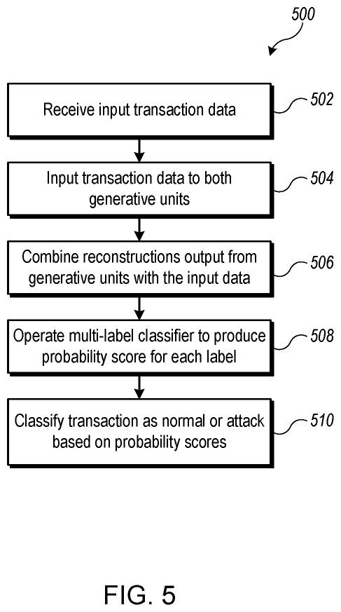

FIG. 5 shows a flow diagram of a process 500 for operating machine learning model 200 in inference mode according to some embodiments. Process 500 can be used, e.g., in monitoring system 110 of FIG. 1 when one of server systems 104 requests real-time evaluation of a transaction in progress.

At block 502, input transaction data 402 can be received (e.g., from server system 104). The input transaction data can be represented as a feature vector corresponding to the feature vectors used in training of machine learning model 200. At block 504, the transaction data (feature vector) is routed to both of normal generative unit 210 and attack generative unit 220, which produce normal reconstruction 418 and attack reconstruction 428, respectively. At block 506, join gate 208 can combine or concatenate input transaction data 402 with normal reconstruction 418 and attack reconstruction 428 (in the same manner as in training mode). At block 508, multi-label classifier unit 230 operates to produce probability scores 434, 436, 438 for the labels in label set 232. At block 510, based on probability scores 434, 436, 438, the transaction can be classified as a normal transaction or an attack transaction.

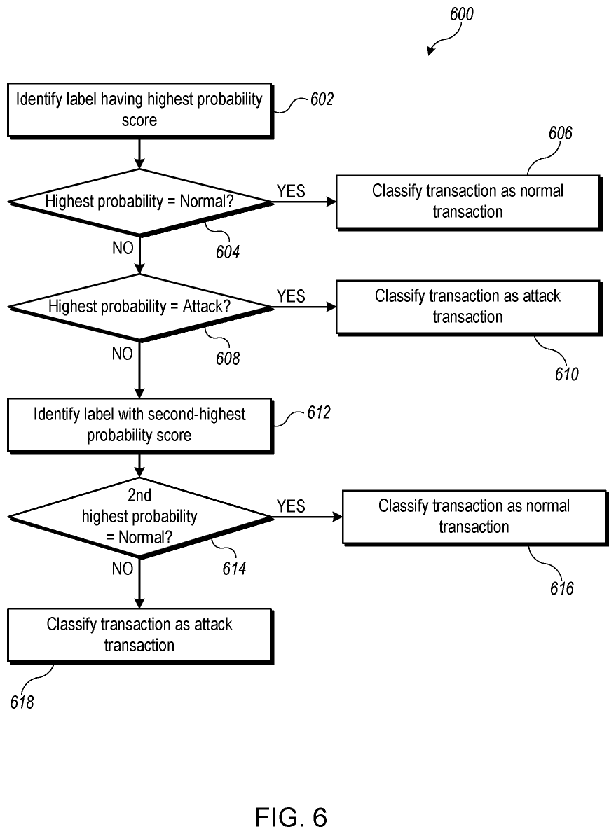

Various classification logic processes can be implemented at block 510. By way of example, FIG. 6 shows a flow diagram of a process 600 for classifying a transaction according to some embodiments. Process 600 can be used at block 510 of process 500 in instances where it is desirable to make a binary classification of a transaction as either a normal transaction or an attack transaction.

At block 602, the probability scores 434, 436, 438 for the different labels in label set 232 are compared to identify the label with the highest probability score. If, at block 604, the Normal label has the highest probability score, then at block 606, the transaction is classified as a normal transaction. If, at block 608, the Attack label has the highest probability score, then at block 610, the transaction is classified as an attack transaction. If, at block 608, neither the Normal label nor the Attack label has the highest probability score, then the Uncertain label has the highest probability score and process 600 proceeds to block 612.

At block 612, the probability scores for the Normal and Attack labels are compared to determine which has the second-highest probability score (with the Uncertain label having the highest score). If, at block 614, the Normal label has the second-highest probability score, then at block 616, the transaction is classified as a normal transaction; otherwise, at block 618, the transaction is classified as an attack transaction.

The decision logic of process 600 can be summarized as follows: If the label with the highest probability score is either the Normal label or the Attack label, then the transaction is classified as the corresponding type. If the label with the highest probability score is the Uncertain label, then the transaction is classified as the type corresponding to the label with the second highest probability score. It should be understood that the classification determined using processes 500 and 600 represents whether it is more likely that the transaction is normal or an attack and that some transactions may be incorrectly classified. As with other fraud-detection techniques, machine learning model 200 need not be foolproof.

The final classification determined from process 600 can be used in various ways. For instance, monitoring system 110 can send a report to requesting server system 104 indicating whether the transaction was classified as normal or an attack. In some embodiments, the probability score 438 for the Uncertain label can be provided as an uncertainty score associated with the classification. Other information (e.g., all of the probability scores 434, 436, 438) can also be included in the report. Server system 104 can use the report to determine whether to allow or reject a transaction in progress. In some embodiments, server system 104 can be configured to reject transactions classified as attacks if the uncertainty score is below a threshold and to allow other transactions (assuming the account credentials are valid and any other requirements imposed by server system 104 are met). If desired, the transaction data can be added to the training data set, with the classification being used to apply a label. In some embodiments, for transaction data where the Uncertain label has the highest probability score, the label for training purposes can be set to Uncertain.

Other uses for classification information include analyzing attack frequency. For instance, if the fraction of transactions at a particular server (or across multiple servers) that are classified as attacks shows an increase, this may indicate an attack in progress, and the sever(s) being targeted may implement additional security precautions, such as requiring additional verification steps or declining all transactions for some period of time.

Process 600 is illustrative, and other decision logic processes can be used to assign a final classification to a transaction based on the probability scores output from machine learning model 200. In some embodiments, monitoring system 110 can provide probability scores 434, 436, 438 for each label in label set 232 to the server system 104 involved in a given transaction, and server system 104 can implement process 600 or other processes to determine whether to allow or reject a transaction.

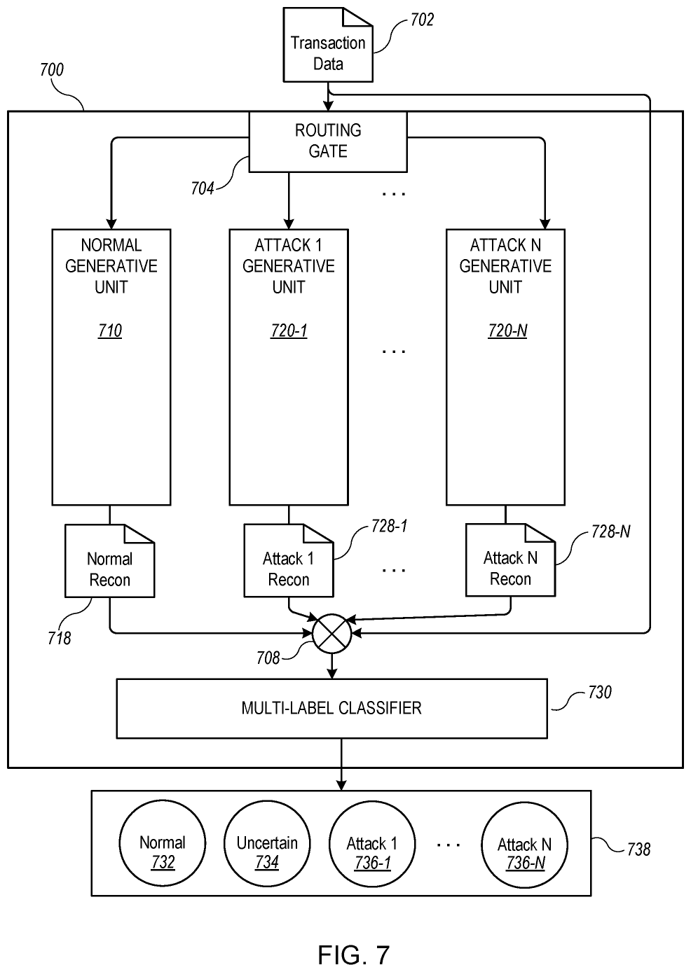

In some embodiments, machine learning models similar to machine learning model 200 can be used to distinguish multiple types of attacks from each other as well as from normal transactions. FIG. 7 shows a simplified block diagram of a machine learning model 700 according to some embodiments. Machine learning model 700 can distinguish a number (N) of different types of attacks. To do so, machine learning model 700 includes a normal generative unit 710 and N separate attack generative units 720-1 through 720-N. Each generative unit can be a VAE (e.g., as described above for normal generative unit 210 and attack generative unit 220 of machine learning model 200) or other generative machine learning (or artificial intelligence) unit, and different ones of normal generative unit 710 and attack generative units 720-1 through 720-N can have identical, similar, or disparate internal structures. Normal generative unit 710 can produce a normal reconstruction 718, and each attack generative unit 720-1 through 720-N can produce an attack reconstruction 728-1 through 728-N. To the extent that different types of attacks have differences in their characteristics, attack reconstructions 728-1 through 728-N will differ from each other as well as from normal reconstruction 718. Join gate 708 can combine or concatenate normal reconstruction 718 and attack reconstructions 728-1 through 728-N with the input transaction data 702, similarly to join gate 208 described above. Multi-label classifier unit 730 can be a feed-forward neural network or other machine learning classifier (similar to multi-label classifier unit 230 described above) that is trained to assign a probability score to each of a number of labels 732, including a Normal label 734, an Uncertain label 736, and a set of N Attack labels 738-1 through 738-N corresponding to the number of different types of attacks to be distinguished. Routing gate 704 can be used to route transaction data 702 to one or more of normal generative unit 710 and attack generative units 720-1 through 720-N. For instance, in training mode, routing gate 704 can operate similarly to label gate 204 and selection gate 206 of machine learning model 200, with labeled transaction data 702 being routed to the corresponding one of generative units 710, 720-1 through 720-N and an empty vector to all other generative units 710, 720-1 through 720-N, while unlabeled transaction data 702 can be routed randomly based on the probability of each different type of attack. For instance, a random drop-out gate or random selection gate (analogous to selection gate 206) described above can be implemented, with the probability of a particular routing depending on the fraction of transactions expected to be attacks of a particular type.

Training of machine learning model 700 can proceed similarly to training of machine learning model 200 described above, with appropriately modified loss functions. In inference mode, routing gate 704 can route input transaction data to all of normal generative unit 710 and attack generative units 720-1 through 720-N.

In this manner, any number and combination of attack types can be distinguished. For instance, enumeration attacks might be distinguished from account-testing attacks. The number and combination of attack types in a particular implementation can be chosen based on design considerations such as available resources (since each generative unit may be computationally intensive), the ability to detect or define distinctions between different types of attacks, and the availability of training data for each type of attack.

### Additional Embodiments

While the invention has been described with reference to specific embodiments, those skilled in the art will appreciate that variations and modifications are possible. For instance, different machine learning models or algorithms can be used, including any type of generative model and/or any type of multi-label (or multi-class) classifier model. Different types of generative models can be used for different transaction types in any combination. Training data can include data from any number of transactions and can initially include any combination of labeled and/or unlabeled transactions, including cases where none of the training data is initially labeled as an attack or normal transaction. As described above, labels can be added or updated during training, thereby increasing the availability of labeled training data as training progresses. (It is noted that a training data set that initially includes at least some labeled transactions may result in more efficient training; however initial labeling is not required.) The machine learning model can be retrained from time to time (e.g., on a daily, weekly, monthly, or yearly basis) as new data becomes available. In some embodiments, old data points can expire and be removed from the training sets prior to retraining.

Ensemble machine learning models of the kind described herein can be used to distinguish normal transactions from attack transactions in a variety of contexts. Examples include enumeration attacks in which the attacker attempts to guess a credential (e.g., password or account number) and/or testing attacks in which the attacker attempts to determine whether a credential it has acquired is valid. In some embodiments, multiple types of attacks can be distinguished. As noted above, a machine learning model can be constructed for transactions at a single server or transactions at multiple servers.

Classification information produced by the machine learning model, including probability scores for various labels and/or a final classification of a transaction as attack or normal, can be used in various applications. For example, as described above, the classification information can be used to determine whether to allow or reject a transaction in progress at a server. In addition, classification information can be accumulated over time, e.g., by monitoring system 110, and can be used to monitor attack activity at one or more server systems. For instance, the fraction of transactions classified as attack may increase when an attack is in progress. When an increase or decrease in attack activity is detected, monitoring system 110 can alert one or more server systems 104 to an increased or decreased threat level, and server system(s) 104 can dynamically adjust security measures based on the threat level.

All processes described herein are illustrative and can be modified. Operations can be performed in a different order from that described, to the extent that logic permits; operations described above may be omitted or combined; and operations not expressly described above may be added.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer-readable storage medium; suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable storage medium may be any combination of one or more such storage devices, and suitable media may be packaged with a compatible device. Any such computer-readable storage medium may reside on or within a single computer product (e.g. a hard drive, a CD, or an entire computer system), and may be present on or within different computer products within a system or network.

Such programs may also be encoded and transmitted using carrier signals adapted for transmission via wired, optical, and/or wireless networks conforming to a variety of protocols, including the Internet. As such, a computer-readable transmission medium may be created using a data signal encoded with such programs. e.g., to download via the internet. It should be understood that transmission media are transitory and distinct from computer-readable storage media, which are non-transitory.

Any of the methods described herein may be totally or partially performed with a computer system including one or more processors, which can be configured to perform the steps, e.g., by providing suitable program code for execution by the processors. Thus, embodiments can involve computer systems configured to perform the steps of any of the methods described herein, potentially with different components performing a respective steps or a respective group of steps. Although presented as numbered steps or blocks, steps of methods described herein can be performed at a same time or in a different order. Additionally, portions of these steps may be used with portions of other steps from other methods. Also, all or portions of a step may be optional. Additionally, some or all steps of any of the methods can be performed with logic modules, circuits, or other means for performing these steps.

While various components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code. Various blocks might or might not be reconfigurable depending on how the initial configuration is obtained. Embodiments of the present invention can be realized in a variety of apparatus including electronic devices implemented using a combination of circuitry and software.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

The above description is illustrative and is not restrictive. Many variations of the invention will become apparent to those skilled in the art upon review of the disclosure. The scope of patent protection should, therefore, be determined not with reference to the above description, but instead should be determined with reference to the following claims along with their full scope or equivalents.

What is claimed is:

1. A computer-implemented method comprising:
obtaining transaction data for a transaction;
providing the transaction data as input data to a machine learning model that has been trained to classify transactions using a set of labels, wherein the set of labels includes a first label indicating a normal transaction type, a second label indicating an attack transaction type, and a third label indicating a transaction of uncertain type, wherein the machine learning model includes:
a plurality of generative units including a first generative unit associated with the normal transaction type and a second generative unit associated with the attack transaction type, wherein each of the generative units receives the input data and outputs a reconstruction of the input data, wherein the generative units operate independently of each other;
a join gate that produces intermediate data by combining respective reconstruction outputs from the plurality of generative units with the input data; and
a multi-label classifier unit that determines, based on the intermediate data, a probability score for each of the labels in the set of labels; and
classifying the transaction as a normal transaction or an attack transaction based at least in part on the probability score for each of the labels in the set of labels.

2. The method of claim 1 further comprising:
obtaining a training data set comprising transaction data for a plurality of transactions, wherein at least some of the transaction data in the training data set is initially unlabeled; and
using the training data set to train the machine learning model,
wherein training the machine learning model includes:
directing transaction data having the first label to the first generative unit;
directing transaction data having the second label to the second generative unit; and
directing unlabeled transaction data and transaction data having the third label randomly to one or more of the generative units.

3. The method of claim 2 wherein some of the transaction data in the training data set is initially labeled.

4. The method of claim 2 wherein training of the machine learning model includes a plurality of training epochs and wherein at the end of each training epoch, an updated label is assigned to the transaction data for at least one of the transactions in the training data set based on the probability scores determined by the multi-label classifier unit.

5. The method of claim 1 wherein classifying the transaction includes:
determining which label of the set of labels has a highest probability score;
in the event that the first label has the highest probability score, classifying the transaction as a normal transaction;
in the event that the second label has the highest probability score, classifying the transaction as an attack transaction; and
in the event that the third label has the highest probability score:
determining which label of the set of labels has a second-highest probability score;
in the event that the first label has the second-highest probability score, classifying the transaction as a normal transaction; and
in the event that the second label has the second-highest probability score, classifying the transaction as an attack transaction.

6. The method of claim 5 further comprising:
assigning an uncertainty score to the classification of the transaction as a normal transaction or an attack transaction based on the probability score for the third label.

7. The method of claim 1 wherein the transaction data is received while a transaction is in progress and wherein the method further comprises:
determining whether to allow or reject the transaction based at least in part on whether the transaction is classified as a normal transaction or an attack transaction.

8. A computer system comprising:
a communication interface to communicate with one or more server systems;
a memory to store transaction data for a plurality of previous transactions including a plurality of normal transactions and a plurality of attack transactions; and
a processor coupled to the memory and configured to implement a machine learning model that includes:
a plurality of generative units including a first generative unit associated with a normal transaction type and a second generative unit associated with an attack transaction type, wherein each of the generative units receives input data representing a transaction and outputs a reconstruction of the input data, wherein the generative units operate independently of each other;
a join gate that produces intermediate data by combining respective outputs from the plurality of generative units with the input data; and
a multi-label classifier unit that determines, based on the intermediate data, a probability score for each label in a set of labels, wherein the set of labels includes a first label indicating the normal transaction type, a second label indicating the attack transaction type, and a third label indicating a transaction of uncertain type,
wherein the processor is further configured to:
train the machine learning model using the stored transaction data;
receive, via the communication interface, new transaction data from one of the one or more server systems;
use the trained machine learning model to determine, for the new transaction data, a probability score for each of the labels in the set of labels; and
classifying the transaction as a normal transaction or an attack transaction based at least in part on the probability score for each of the labels in the set of labels.

9. The computer system of claim 8 wherein at least one of the generative units includes a variational autoencoder.

10. The computer system of claim 8 wherein the multi-label classifier unit includes a feed-forward neural network having one or more layers.

11. The computer system of claim 8 wherein the transaction data for each transaction includes an account credential provided by a client system to the server system, wherein the normal transaction type corresponds to an authorized use of the account credential and wherein the attack transaction type corresponds to an attempted or successful unauthorized use of the account credential.

12. The computer system of claim 8 wherein the processor is further configured such that training the machine learning model includes:
defining a training data set using at least a portion of the stored transaction data, wherein the training data set initially includes at least some transactions having the first label, at least some transactions having the second label, at least some transactions having the third label and at least some unlabeled transactions;
directing transaction data for transactions having the first label to the first generative unit; and
directing transaction data having the second label to the second generative unit.

13. The computer system of claim 12 wherein the processor is further configured such that training the machine learning model includes:
randomly directing each of the transactions having the third label to one or the other of the first generative unit or the second generative unit; and
randomly directing each of the unlabeled transactions to one or the other of the first generative unit or the second generative unit.

14. The computer system of claim 12 wherein the processor is further configured such that training the machine learning model includes:
directing a randomly selected subset of the transactions having the third label to both of the first generative unit and the second generative unit; and
directing a randomly selected subset of the unlabeled transactions to both of the first generative unit and the second generative unit.

15. The computer system of claim 12 wherein training of the machine learning model includes a plurality of training epochs and wherein the processor is further configured such that, at the end of each training epoch, updated labels are determined for transactions in the training data set that have the third label and for unlabeled transactions, wherein the updated label for a transaction is determined based on the probability scores determined by the multi-label classifier unit.

16. A computer-readable storage medium having stored therein program code instructions that, when executed by a processor in a computer system, cause the processor to perform a method comprising:
obtaining transaction data for a transaction;
providing the transaction data as input data to a machine learning model that has been trained to classify transactions using a set of labels, wherein the set of labels includes a first label indicating a normal transaction type, a second label indicating an attack transaction type, and a third label indicating a transaction of uncertain type, wherein the machine learning model includes:
a plurality of generative units including a first generative unit associated with the normal transaction type and a second generative unit associated with the attack transaction type, wherein each of the generative units receives the input data and outputs a reconstruction of the input data, wherein the generative units operate independently of each other;
a join gate that produces intermediate data by combining respective outputs from the plurality of generative units with the input data; and
a multi-label classifier unit that determines, based on the intermediate data, a probability score for each of the labels in the set of labels; and
classifying, based at least in part on the probability score for each of the labels in the set of labels, the transaction as a normal transaction or an attack transaction.

17. The computer-readable storage medium of claim 16 wherein the method further comprises:
obtaining a training data set comprising transaction data for a plurality of transactions, wherein at least some of the transaction data in the training data set is initially unlabeled; and
using the training data set to train the machine learning model,
wherein training the machine learning model includes a plurality of training epochs and wherein, during each epoch:
transaction data having the first label is directed to the first generative unit;
transaction data having the second label is directed to the second generative unit; and
unlabeled transaction data and transaction data having the third label is directed randomly to zero or more of the generative units.

18. The computer-readable storage medium of claim 17 wherein the method further comprises, after each training epoch:
applying the machine learning model to unlabeled transaction data and transaction data having the third label to determine probability scores for each of the labels in the set of labels; and
determining updated labels for the unlabeled transaction data and transaction data having the third label based on the probability scores for each of the labels in the set of labels.

19. The computer-readable storage medium of claim 17 wherein the transaction data is received from a server computer and wherein the method further comprises:
transmitting a report to the server computer, the report indicating whether the transaction was classified as a normal transaction or an attack transaction.

20. The computer-readable storage medium of claim 19 wherein the report further includes an uncertainty score based on the probability score for the third label.
